(19) United States
(12) Patent Application Publication
(10) Pub. No.: US 2015/0213452 A1
(43) Pub. Date: Jul. 30, 2015

(54) ELECTRONIC PAYMENT SYSTEM AND METHOD

(71) Applicant: Golden Vast Macao Commercial Offshore Limited, Macau (CN)

(72) Inventor: KwokFong Wong, Heshan City (CN)

(21) Appl. No.: 14/497,868

(22) Filed: Sep. 26, 2014

(30) Foreign Application Priority Data
Jan. 24, 2014 (CN) 201410036805.1

(51) Int. Cl. G06Q 20/40; G06Q 20/32

(52) U.S. Cl. CPC G06Q 20/40145; G06Q 20/3227

(57) ABSTRACT

The invention discloses a payment system and method based on biometric authentication. The payment system comprises a biometric authentication device, a mobile terminal and an authorization payment subsystem. The biometric authentication device is used for extraction biometric information of a user and storing the biometric information and the authorization payment information of the receiving party, and the authorization payment information is transmitted to the mobile terminal after the biometric information is authenticated by the biometric authentication device. The mobile terminal is provided with a short-distance communication module, and the biometric information and the authorization payment information is transmitted between the mobile terminal and the authorization payment subsystem so that short-distance payment is achieved. The authorization payment subsystem is used for matching the payment information contained in the payment request with the user information stored in the authorization payment subsystem when receiving a payment request from the mobile terminal. The safety of payment can be guaranteed for a user due to the dual confirmation in the invention.

### FIELD OF THE INVENTION

The invention relates to the field of electronic technology, more particularly to an electronic payment system and method.

### DESCRIPTION OF THE RELATED ART

Currently, the online payment generally is achieved in two ways in a bank system, including using an USBkey, or using a mobile message and an electronic password card distributed by a bank. After analyzing the methods in the prior art, it is recognized that the safety is improved in the conventional method by authenticating using a mobile message and electronic password card distributed by the bank, however, this method has the following disadvantages: the cost is increased for a user because he/she must pay for the electronic password card which is distributed by the bank, and obviously it is inconvenient for a user to carry the electronic password card. Furthermore, online transaction can not be achieved when the electronic password card is absent, this also leads to inconvenience for the user.

### SUMMARY OF THE INVENTION

In order to solve the problems of the prior art, the invention discloses an electronic payment system and method, and the technical solutions of the invention are disclosed as follows:

In one aspect, the invention discloses an electronic payment system, comprising
an authorization payment subsystem; and
a mobile terminal which is provided with a micro-processing chip and a biometric authentication device, the micro-processing chip comprising a first micro-processing unit for controlling the communication between the mobile terminal and the authorization payment subsystem, and a second micro-processing unit for encrypting or decrypting the data to be transferred between the mobile terminal and the authorization payment subsystem;
wherein when payment is achieved via internet by a user,
a confirmation message is received by the mobile terminal from the authorization payment subsystem, and a message code is input via the mobile terminal, and then the message code is transmitted to the authorization payment subsystem via a communication interface under the control of the first micro-processing unit, thereby achieving the preliminary confirmation; and
identity authentication is performed on the user by means of the biometric authentication device, an encrypted random confirmation code is generated by the second micro-processing unit according to an authorization payment protocol permitted by the authorization payment subsystem, and then the random confirmation code is transmitted to the authorization payment subsystem via the communication interface under the control of the first micro-processing unit, thereby achieving the secondary confirmation.

In another aspect, the invention discloses an electronic payment method, comprising steps of: when payment is achieved via internet by a user,
a mobile terminal receiving a confirmation message from an authorization payment subsystem, inputting a message code via the mobile terminal, and transmitting the message code to the authorization payment subsystem via a communication interface under the control of a first micro-processing unit disposed in the mobile terminal, thereby achieving the preliminary confirmation; and
performing identity authentication on the user by means of a biometric authentication device, a second micro-processing unit disposed in the mobile terminal generating an encrypted random confirmation code according to an authorization payment protocol permitted by the authorization payment subsystem, and transmitting the random confirmation code to the authorization payment subsystem via a communication interface under the control of the first micro-processing unit, thereby achieving the secondary confirmation.

As compared with the prior art, the invention has the following advantages: by transmitting a message code and a random confirmation code to an authorization payment subsystem under the control of a first micro-processing unit, and by authenticating a user via a biometric authentication device, dual confirmation is achieved in the invention and thus the safety of online payment is guaranteed for a user. Furthermore, the mobile terminal comprises a first micro-processing unit, a second micro-processing unit and a biometric authentication device, thus a transaction can be completed by means of one mobile terminal of an embodiment of the invention, and the transaction can be completed quickly and conveniently while the safety is guaranteed.

### BRIEF DESCRIPTION OF THE DRAWINGS

The accompanying drawings of the embodiments will now be described simply, so that the technical solutions of embodiments of the invention can be illustrated more clearly. Obviously, the drawings described hereinafter only refer to some preferred embodiments of the present invention, and other equivalent drawings can be obtained by a person skilled in the art without any creative works.

FIG. 1 is a schematic diagram of an electronic payment system according to embodiment 1 of the invention;

FIG. 2 is a schematic diagram of an electronic payment system according to embodiment 2 of the invention;

FIG. 3 is a flow chart of an electronic payment method according to embodiment 3 of the invention;

FIG. 4 is a schematic diagram of an electronic payment system applicable to embodiments of the invention.

### DETAILED DESCRIPTION OF THE INVENTION

Preferred embodiments of the present invention will now be described in more detail hereinafter with reference to the drawings, so that the advantages and features of the invention can be easily understood by a person skilled in the art, thereby the protection scope of the invention can be defined more clearly.

### Embodiment 1

FIG. 1 is a schematic diagram of an electronic payment system according to an embodiment 1 of the invention. As shown in FIG. 1, the electronic payment system 100 in this embodiment specifically comprises a mobile terminal 11, an authorization payment subsystem 12, wherein the mobile terminal 11 is provided with a micro-processing chip 15, a biometric authentication device 13 and a communication interface 14, the micro-processing chip 15 comprises a first micro-processing unit 151 and a second micro-processing unit 152, the first micro-processing unit is used for controlling the communication between the mobile terminal and the authorization payment subsystem 12, and the second micro-processing unit 152 is used for encrypting or decrypting the data to be transferred between the mobile terminal and the authorization payment subsystem 12.

When payment is achieved via internet by a user, a confirmation message is received by the mobile terminal 11 from the authorization payment subsystem 12, and a message code is inputted via the mobile terminal 11, and then under the control of the first micro-processing unit 151, the message code is transmitted to the authorization payment subsystem 12 via the communication interface 14, thereby achieving the preliminary confirmation. Furthermore, identity authentication is performed on the user by means of the biometric authentication device 13, after the user has been authenticated, the second micro-processing 152 generates an encrypted random confirmation code according to an authorization payment protocol permitted by the authorization payment subsystem 12, and then under the control of the first micro-processing unit 151, the random confirmation code is transmitted to the authorization payment subsystem 12 via the communication interface 14, thereby achieving the secondary confirmation.

In the electronic payment system of this embodiment of the invention, by transmitting the message code and random confirmation code to the authorization payment subsystem 12 under the control of the micro-processing unit 151, and by authenticating the user by means of the biometric authentication device, dual confirmation is achieved, thus, the safety of online payment can be guaranteed for the user. Furthermore, the mobile terminal of the embodiment comprises a first micro-processing unit 151, a second micro-processing unit 152 and a biometric authentication device 13, thus a transaction can be completed only by means of one mobile terminal 11 of this embodiment of the invention, and the transaction is completed quickly and conveniently while the safety is guaranteed.

### Embodiment 2

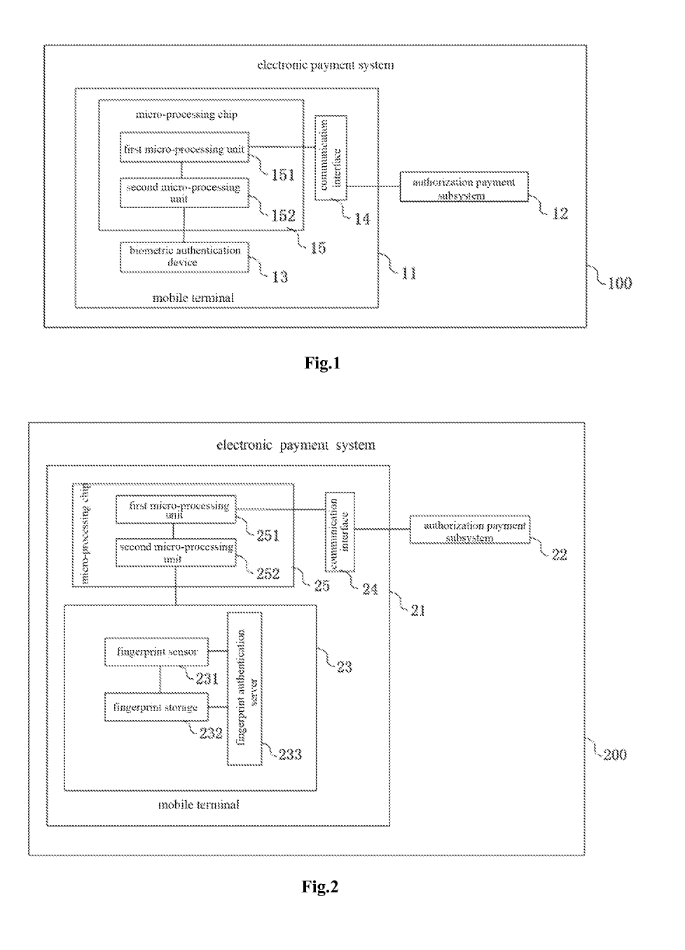

FIG. 2 is a schematic diagram of an electronic payment system according to an embodiment 2 of the invention. Specifically, the biometric authentication device of this embodiment is a fingerprint authentication device. As shown in FIG. 2, the electronic payment system 200 of this embodiment of the invention comprises a mobile terminal 21 and an authorization payment subsystem 22, wherein the mobile terminal 21 is provided with a micro-processing chip 25, a fingerprint authentication device 23 and a communication interface 24. The micro-processing chip 25 comprises a first micro-processing unit 251 and a second micro-processing unit 252. The first micro-processing unit 251 is used for controlling the communication between the mobile terminal 21 and the authorization payment subsystem 22, the second micro-processing unit is used for encrypting or decrypting the data to be transferred between the mobile terminal 21 and the authorization payment subsystem 22.

When a user achieves payment via internet, a confirmation message is received by the mobile terminal 21 from the authorization payment subsystem 22, a message code is inputted via the mobile terminal 21, and under the control of the first micro-processing unit 251, the message code is transmitted to the authorization payment subsystem 22 via the communication interface 24, thereby achieving the first confirmation. Preferably, the confirmation message from the authorization payment subsystem 22 can be encrypted by the authorization payment subsystem 22, and the encrypted confirmation message is decrypted by the second micro-processing 252 after it is received by the mobile terminal 21, to obtain a decrypted confirmation message.

Identity authentication is performed on the user by the fingerprint authentication device 23, after the user has been authenticated, the second micro-processing 252 generates an encrypted random confirmation code according to an authorization payment protocol permitted by the authorization payment subsystem 22, and under the control of the first micro-processing unit 251, the random confirmation code is transmitted to the authorization payment subsystem 22 via the communication interface 24, thereby achieving the secondary confirmation. When the message code and the random confirmation code are received by the authorization payment subsystem 22, deduction is performed on the corresponding online account of the user.

Preferably, the fingerprint authentication device 23 further comprises a fingerprint sensor 231, a fingerprint storage 232 and a fingerprint authentication server 233. The fingerprint sensor 231 is used for extracting the fingerprint information of the user under the control of the first micro-processing unit 251, the finger storage 232 is used for registering and storing the fingerprint information extracted by the fingerprint sensor 231, and the fingerprint authentication server 233 is used for authenticating the fingerprint information extracted by the fingerprint sensor 231 under the control of the first micro-processing unit by comparing with the fingerprint information of an authorized user registered and stored in the fingerprint storage 232, to confirm that the fingerprint information extracted by the fingerprint sensor 231 is the fingerprint information of the authorized user. A person skilled in the art can appreciate that, the fingerprint sensor 231 can be a touch sensor, or a scanning sensor. Different fingerprint sensors can be used in different types of mobile terminals, and the specific structure of fingerprint sensor 231 is not limited in the embodiments of the invention.

More preferably, the communication interface 24 specifically comprises:
a data transmission interface of a customer identification module, for achieving the data transmission between the mobile terminal and the authorization payment subsystem under the control of the first micro-processing unit; and/or
a network interface of Wi-Fi network, for achieving network connection between the mobile terminal and the authorization payment subsystem.

More preferably, the first micro-processing unit 251 is communicated with the second micro-processing unit 252 via an asynchronous transmitting-receiving transmitter interface.

A person skilled in the art can appreciate that, in the embodiment of the invention, the biometric authentication device is specifically described as a fingerprint authentication device 23 by way of example, the biometric authentication device also can comprises a high-resolution image sensor, and a user can be authenticated by means of facial features, iris information or blood capillary of the user which are extracted by the image sensor.

In the electronic payment system of this embodiment of the invention, by transmitting the message code and random confirmation code to the authorization payment subsystem 22 under the control of the micro-processing unit 251, and by authenticating the user by means of the biometric authentication device, dual confirmation is achieved, thus, the safety of online payment can be guaranteed for the user. Furthermore, the mobile terminal of the embodiment comprises a first micro-processing unit 251, a second micro-processing unit 252 and a biometric authentication device 23, thus a transaction can be completed only by means of one mobile terminal 21 of this embodiment of the invention, and the transaction is completed quickly and conveniently while the safety is guaranteed.

Preferably, in the above embodiment 2, the micro-processing unit 251 also can control a hardware arranged on the mobile terminal 21, for example, the fingerprint sensor 231, an external device on the mobile terminal 21 and any hardware connected or mounted on the mobile terminal 21. The second micro-processing unit 252 also can control software's installed on the mobile terminal 21, specifically, including the communication and controlling or the like between the software's.

### Embodiment 3

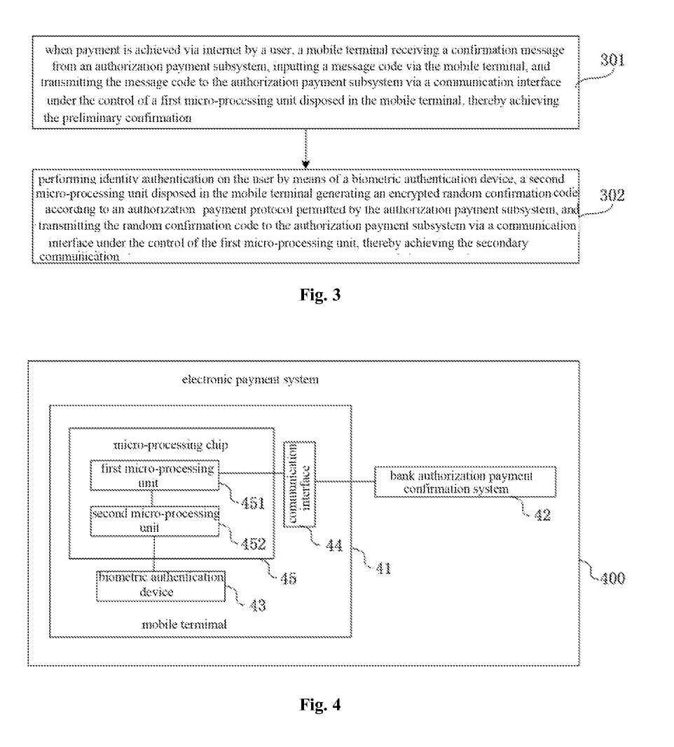

FIG. 3 is a flow chart of an electronic payment method according to an embodiment 3 of the invention, and this embodiment can be implemented by means of the electronic payment system in the embodiment 1 or 2. As shown in FIG. 3, the electronic payment method of this embodiment of the invention specifically comprises the steps of:
step 301: when payment is achieved via internet by a user, a mobile terminal receiving a confirmation message from an authorization payment subsystem, inputting a message code via the mobile terminal, and transmitting the message code to the authorization payment subsystem via a communication interface under the control of a first micro-processing unit disposed in the mobile terminal, thereby achieving the first confirmation;
step 302: performing identity authentication on the user by means of a biometric authentication device, a second micro-processing unit disposed in the mobile terminal generating an encrypted random confirmation code according to an authorization payment protocol permitted by the authorization payment subsystem, and transmitting the random confirmation code to the authorization payment subsystem via a communication interface under the control of the first micro-processing unit, thereby achieving the secondary confirmation.

In the electronic payment method of this embodiment of the invention, by transmitting the message code and random confirmation code to the authorization payment subsystem under the control of the micro-processing unit, and by authenticating the user by means of the biometric authentication device, dual confirmation is achieved, thus, the safety of online payment can be guaranteed for the user. Furthermore, the mobile terminal of the embodiment comprises a first micro-processing unit, a second micro-processing unit and a biometric authentication device, thus a transaction can be completed only by means of one mobile terminal of this embodiment of the invention, and the transaction is completed quickly and conveniently while the safety is guaranteed.

Preferably, in the above embodiment 3, when the biometric authentication device specifically is a fingerprint authentication device, “performing identity authentication on the user by means of a biometric authentication device” in the step 302 specifically may comprises:
extracting the fingerprint information of the user by means of a fingerprint sensor;
registering and storing the fingerprint information extracted by the fingerprint sensor by means of a fingerprint storage;
authenticating the fingerprint information extracted by the fingerprint sensor by comparing with the fingerprint information of an authorized user registered and stored in the fingerprint storage by means of the fingerprint authentication server, to confirm that the fingerprint information extracted by the fingerprint sensor is the fingerprint information of the authorized user.

More preferably, in the above embodiment 3, the communication interface comprises a data transmission interface of a customer identification module and/or a network interface of Wi-Fi network,
the data transmission between the mobile terminal and the authorization payment subsystem is achieved via the data transmission interface of the customer identification module under the control of the first micro-processing unit.
the network connection between the mobile terminal and the authorization payment subsystem is achieved via the network interface of Wi-Fi network under the control of the micro-processing unit.

Still other preferably, in the above embodiment 3, the electronic payment method also can comprises communicating between the first micro-processing unit and the second micro-processing unit via a serial interface.

More preferably, in the above embodiment 3, after the step 302 the electronic payment method also may comprise performing deduction on the corresponding online account of the user, when the message code and the random confirmation code are received by the authorization payment subsystem.

### Embodiment 4

FIG. 4 is a schematic diagram of an electronic payment system applicable to embodiments of the invention. In this embodiment of the invention, the authorization payment subsystem specifically is a bank authorization payment confirmation system and the biometric extraction device specifically is a fingerprint sensor by way of example. As shown in FIG. 4, this embodiment of the invention specifically comprises a mobile terminal 41 and a bank authorization payment confirmation system 42. The mobile terminal 41 is provided with a micro-processing chip 45, a fingerprint authentication device 43 and a communication interface 44. The micro-processing chip 45 comprises a first micro-processing unit 451 and a second micro-processing unit 452, the first micro-processing unit 451 is used for controlling the communication between the mobile terminal 41 and the authorization payment subsystem 42, and the second micro-processing unit 452 is used for encrypting or decrypting the data to be transferred between the mobile terminal 41 and the authorization payment subsystem 42.

Wherein the fingerprint authentication device 43 specifically is a fingerprint sensor described in the embodiment 2, and a memory storage is contained in the fingerprint authentication device 43 for storing the fingerprint information of the user.

Specifically, the communication interface 44 may be a communication interface of SIM card, and/or Wi-Fi, or any other access network, and the mobile terminal 41 may be communicated with the bank authorization payment confirmation system by using the data transmission of SIM card/network connection of Wi-Fi, to achieve dual confirmation and effective payment.

Furthermore, the first micro-processing unit 451 is communicated with the second micro-processing unit 452 via a universal asynchronous transmitting-receiving transmitter interface. The mobile terminal 41 is configured as a host microcomputer control centre of an embedded system, and outputs of the mobile terminal 41 are controlled by the first micro-processing unit 451. The first micro-processing unit 451 and the second micro-processing unit 452 bans the operation of the debugging interface by means of an electronic fuse program or a binding program, and performs connecting by means of a universal asynchronous transmitting-receiving transmitter interface.

By adopting the embodiments of the invention, the bank authorization payment confirmation system 42 can perform deduction after the user is authenticated by dual confirmation, thus the safety of the user payment is guaranteed. Furthermore, the mobile terminal is connected with the bank authorization payment confirmation system 42 and complete the payment by means of an authorization payment protocol confirmed by the bank, and the mobile terminal 41 comprises the micro-processing chip 45 and the biometric authentication device 43, thus, the mobile terminal 41 is configured as a one-piece online payment electronic device, and by means of the invention the transaction is convenient and quick while the safety is guaranteed.

The numberings of the embodiments are given only for description, instead of representing the quality of the embodiments.

A person skilled in the art shall appreciate that, part or all of the steps achieving the above embodiments can be completed by means of a hardware, or by instructing a related hardware via a program, the program may be stored in a computer-readable storage medium which may be a read only memory (ROM), magnetic disk or optical disc or the like.

The preferred embodiments as above described are not intended for limiting of the invention, any variations, equivalent substitutions, improvements within the spirit and scope of the invention are contained in the extent of protection of the invention.

1. An electronic payment system, comprising:
an authorization payment subsystem; and
a mobile terminal which is provided with a micro-processing chip and a biometric authentication device, the micro-processing chip comprising a first micro-processing unit for controlling the communication between the mobile terminal and the authorization payment subsystem, and a second micro-processing unit for encrypting or decrypting the data to be transferred between the mobile terminal and the authorization payment subsystem;
wherein when payment is achieved via internet by a user,
a confirmation message is received by the mobile terminal from the authorization payment subsystem, and a message code is input via the mobile terminal, and then the message code is transmitted to the authorization payment subsystem via a communication interface under the control of the first micro-processing unit, thereby achieving the preliminary confirmation; and
identity authentication is performed on the user by means of the biometric authentication device, an encrypted random confirmation code is generated by the second micro-processing unit according to an authorization payment protocol permitted by the authorization payment subsystem, and then the random confirmation code is transmitted to the authorization payment subsystem via the communication interface under the control of the first micro-processing unit, thereby achieving the secondary confirmation.

2. The electronic payment system as claimed in claim 1, wherein the biometric authentication device is a fingerprint authentication device comprising:
a fingerprint sensor, for extracting the fingerprint information of the user under the control of the first micro-processing unit;
a fingerprint storage, for registering and storing the fingerprint information of the user extracted by the fingerprint sensor; and
a fingerprint authentication server, for authenticating the fingerprint information extracted by the fingerprint sensor by comparing with the fingerprint information of an authorized user registered and stored in the fingerprint storage under the control of the first micro-processing unit, to confirm that the fingerprint information extracted by the fingerprint sensor is the fingerprint information of the authorized user.

3. The electronic payment system as claimed in claim 1, wherein the communication interface comprises:
a data transmission interface of a customer identification module, for achieving the data transmission between the mobile terminal and the authorization payment subsystem under the control of the first micro-processing unit; and/or
a network interface of a Wi-Fi network, for achieving the network connection between the mobile terminal and the authorization payment subsystem under the control of the first micro-processing unit.

4. The electronic payment system as claimed in claim 1, wherein the first micro-processing unit is communicated with the second micro-processing unit by an asynchronous transmitting-receiving transmitter interface.

5. The electronic payment system as claimed in claim 1, wherein deduction is performed on a corresponding online account of the user when the message code and random confirmation code are received by the authorization payment subsystem.

6. An electronic payment method, comprising steps of:
when payment is achieved via internet by a user,
a mobile terminal receiving a confirmation message from an authorization payment subsystem, inputting a message code via the mobile terminal, and transmitting the message code to the authorization payment subsystem via a communication interface under the control of a first micro-processing unit disposed in the mobile terminal, thereby achieving the preliminary confirmation; and
performing identity authentication on the user by means of a biometric authentication device, a second micro-processing unit disposed in the mobile terminal generating an encrypted random confirmation code according to an authorization payment protocol permitted by the authorization payment subsystem, and transmitting the random confirmation code to the authorization payment subsystem via a communication interface under the control of the first micro-processing unit, thereby achieving the secondary confirmation.

7. The electronic payment method as claimed in claim 6, wherein the biometric authentication device is a fingerprint authentication device, and the step of performing identity authentication on the user by means of a biometric authentication device including:
extracting the fingerprint information of the user under the control of the first micro-processing unit by means of a fingerprint sensor;
registering and storing the fingerprint information extracted by the fingerprint sensor by means of a fingerprint storage;
authenticating the fingerprint information extracted by the fingerprint sensor by comparing with the fingerprint information of an authorized user registered and stored in the fingerprint storage under the control of the first micro-processing unit by means of a fingerprint authentication server, to confirm that the fingerprint information extracted by the fingerprint sensor is the fingerprint information of the authorized user.

8. The electronic payment method as claimed in claim 6, wherein the communication interface comprises a data transmission interface of a customer identification module and/or a network interface of Wi-Fi network,
the data transmission between the mobile terminal and the authorization payment subsystem being achieved via the data transmission interface of the customer identification module under the control of the first micro-processing unit, and/or
the network connection between the mobile terminal and the authorization payment subsystem being achieved via the network interface of Wi-Fi network under the control of the first micro-processing unit.

9. The electronic payment method as claimed in claim 6, wherein the method further comprises:
encrypting the payment data transmitted between the mobile terminal and the authorization payment subsystem by means of the second micro-processing unit, and transmitting the encrypted payment data to the authorization payment subsystem via the communication interface under the control of the first micro-processing unit; and
performing communication between the first micro-processing unit and the second micro-processing unit by means of an asynchronous transmitting-receiving transmitter interface.

10. The electronic payment method as claimed in claim 6, wherein the method further comprises:
performing deduction on a corresponding online account of the user, when the message code and the random confirmation code are received by the authorization payment subsystem.

11. The electronic payment system as claimed in claim 2, wherein deduction is performed on a corresponding online account of the user when the message code and random confirmation code are received by the authorization payment subsystem.

12. The electronic payment system as claimed in claim 3, wherein deduction is performed on a corresponding online account of the user when the message code and random confirmation code are received by the authorization payment subsystem.

13. The electronic payment system as claimed in claim 4, wherein deduction is performed on a corresponding online account of the user when the message code and random confirmation code are received by the authorization payment subsystem.

14. The electronic payment method as claimed in claim 7, wherein the method further comprises:
performing deduction on a corresponding online account of the user, when the message code and the random confirmation code are received by the authorization payment subsystem.

15. The electronic payment method as claimed in claim 8, wherein the method further comprises:
performing deduction on a corresponding online account of the user, when the message code and the random confirmation code are received by the authorization payment subsystem.

16. The electronic payment method as claimed in claim 9, wherein the method further comprises:
performing deduction on a corresponding online account of the user, when the message code and the random confirmation code are received by the authorization payment subsystem.
